(19) United States
(12) Patent Application Publication
(10) Pub. No.: US 2008/0028371 A1
(43) Pub. Date: Jan. 31, 2008

(54) Method and system for using application development data to instantiate support information

(76) Inventors: William Brothers, Roseville, CA (US); Caroline N. Koff, Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/492,829

(22) Filed: Jul. 26, 2006

(51) Int. Cl. G06F 9/45

(52) U.S. Cl. 717/136

(57) ABSTRACT

Systems and methods are disclosed for using application development data to instantiate support information and for providing the support information instantiated using the application development data. An exemplary method for providing support information instantiated using application development data includes monitoring the application during run time to detect fault notification points in accordance with trigger definitions specifying contexts that produce the fault notification points, and providing support information corresponding to the detected fault notification points using support documents created based on meta data generated during compilation of application source code. The meta data is generated by automatically detecting marked text strings in the application source code that describe the fault notification points, and extracting from each marked text string support information that corresponds to the fault notification points. The trigger definitions are automatically generated by processing the meta data.

### BACKGROUND

Software application development engineers encode error messages, or fault notification points, in the application source code that can be triggered when the applications are executed. In some cases, the development engineers manually prepare a list or file identifying the fault notification points while developing an application. When errors occur during run time, or execution, of an application, the end-users can access support information to determine what the errors mean and how to remedy the errors.

Techniques for developing support information include preparation of support documents by support engineers, who attempt to identify all of the fault notification points encoded in the applications by the development engineers and develop the support information explaining the fault notification points, including actions the end-users can take to remedy the faults. Other support information development techniques include manual tracking and documentation by the support engineers of the fault notification points and remedies as they are encountered and implemented by the end-users. In these techniques, the support engineers manually develop a support knowledge base after compilation of the source code that can include support information, such as text of the fault notification points, contexts in which the fault notification points occur, and actions that can be taken to remedy the faults.

### SUMMARY

An exemplary method for using application development data to instantiate support information comprises identifying text strings in application source code that describe fault notification points, wherein the text strings comprise support information pertaining to the fault notification points; automatically extracting the support information from each identified text string during compilation of the application source code; generating meta data linking the extracted support information with the corresponding fault notification points using unique identifiers; and creating support documents based on the meta data.

An exemplary system for using application development data to instantiate support information comprises means for automatically detecting, during compilation of application source code, marked text strings describing fault notification points, extracting support information from each marked text string, and generating meta data linking the extracted support information with the corresponding fault notification points using unique identifiers; and means for creating support documents based on the meta data.

An exemplary method for providing support information instantiated using application development data comprises monitoring the application during run time to detect fault notification points in accordance with trigger definitions specifying contexts that produce the fault notification points, and providing support information corresponding to the detected fault notification points using support documents created based on meta data generated during compilation of application source code, wherein the meta data is generated by automatically detecting marked text strings in the application source code that describe the fault notification points and extracting from each marked text string support information that corresponds to the fault notification points, and wherein the trigger definitions are automatically generated by processing the meta data.

An exemplary system for providing support information instantiated using application development data comprises means for monitoring the application during run time to detect fault notification points in accordance with trigger definitions specifying contexts that produce the fault notification points, and means for providing support information corresponding to the detected fault notification points using support documents created based on meta data generated during compilation of application source code, wherein the meta data is generated by automatically detecting marked text strings in the application source code that describe the fault notification points and extracting from each marked text string support information that corresponds to the fault notification points, and wherein the trigger definitions are automatically generated by processing the meta data.

### BRIEF DESCRIPTION OF THE DRAWINGS

Other objects and advantages of the invention will become apparent to those skilled in the relevant art(s) upon reading the following detailed description of preferred embodiments, in conjunction with the accompanying drawings, in which like reference numerals have been used to designate like elements, and in which:

FIG. 1 illustrates an exemplary environment for using application development data to instantiate support information and for providing the support information instantiated using the application development data;

FIG. 2 illustrates an exemplary method for providing support information instantiated using application development data; and

FIG. 3 illustrates an exemplary method for using application development data to instantiate support information.

### DETAILED DESCRIPTION

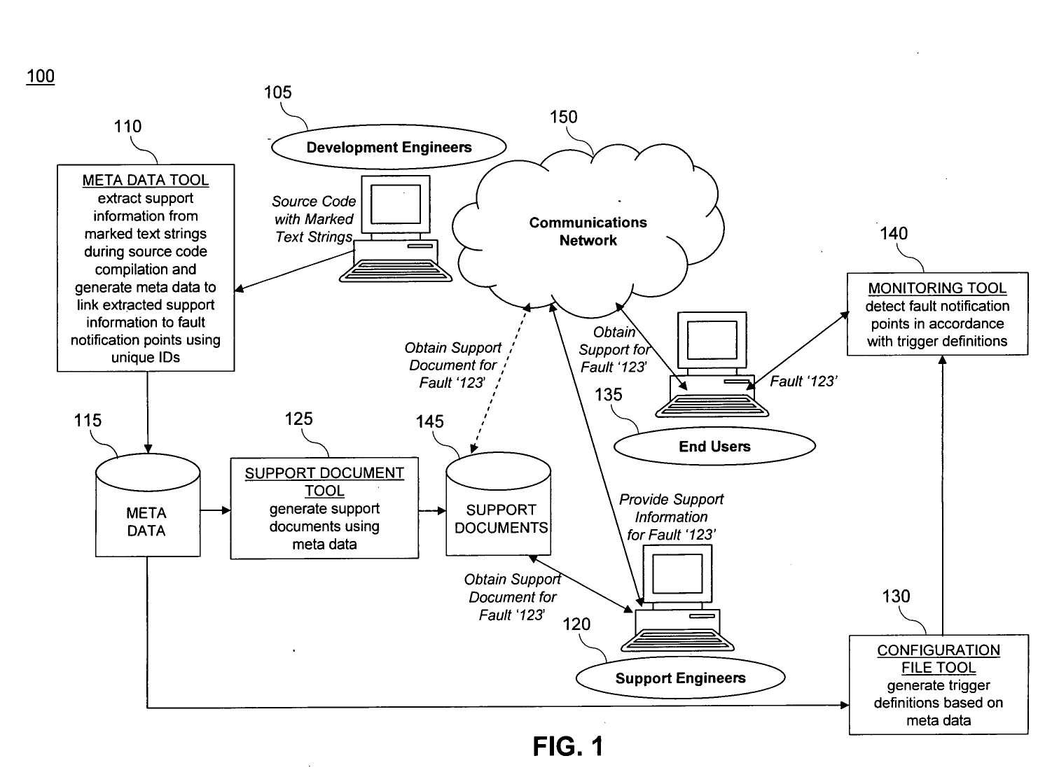

FIG. 1 illustrates an exemplary environment 100 for using application development data to instantiate support information and for providing the support information instantiated using the application development data. The systems and methods for using application development data to instantiate support information, as disclosed herein, can use data generated and maintained as part of product development processes to substantially improve initial knowledge that is loaded into a support knowledge base. Additionally, exemplary embodiments automate manual fault trigger configuration processes in which development engineers create trigger definitions, or configuration files, that specify when an application monitoring program can determine that a fault notification point occurs.

Thus, by using application development data to instantiate support information, the systems and methods, as disclosed herein, can ensure that all fault notification points encoded in applications by development engineers are documented and included in monitoring and support processes. In this way, support engineers can be alleviated from having to respond to end-users about notification points, for which they have no knowledge or documentation, and can also ensure that up-to-date triggering information is available for accurate determination of fault notification points. Exemplary embodiments can automatically generate meta data during the software application build process to improve subsequent monitoring and support processes. The explanation will be by way of exemplary embodiments to which the present invention is not limited.

Exemplary environment 100 includes means, such as meta data tool 110, for automatically detecting, during compilation of application source code, marked text strings describing fault notification points, extracting support information from each marked text string, and generating meta data linking the extracted support information with the corresponding fault notification points using unique identifiers. For example, in the embodiment of FIG. 1, environment 100 includes development engineers 105, who develop source code for software applications. In accordance with an exemplary embodiment, the development engineers 105 can identify text strings in the application source code describing fault notification points by using a predetermined marker or character/character string that is readable by the meta data tool 110. An exemplary marked text string is shown in which a predetermined marker “<%>” is employed to identify a fault notification point.

InvokeError(msgNum, nCritical, “<%>All attempts to
contact client %s have failed! Exiting.</%>”,
clientName)

### Those skilled in the relevant art(s) will understand that other predetermined markers/characters can be used to identify fault notification points in the source code.

Thus, the meta data tool 110 is configured as a recognizer tool for parsing out portions of source code, which are identified using a predetermined marking mechanism and which describe error messages, or fault notification points. Various, readily available, external tools can be configured to read source code comments (e.g., existing tools can be used to generate API documentation in HTML format from comments in the source code). An example of an external tool configured to read source code comments is described in U.S. Pat. No. 7,024,365, assigned to Hewlett-Packard Development Company, L.P. (Koff et al.), which is herein incorporated by reference in its entirety. The tool described in the '365 patent can extract marked localizable text strings of source code on which an internationalization tool can be run.

Similarly, the meta data tool 110 is configured to automatically extract support information from each marked text string in the source code describing fault notification points. The support information for each marked text string can include fault notification point text, such as the text of the error message that will be displayed to an end user when the fault notification point is triggered during run time. The support information can also include the context, or conditions, that produced the fault, as well as actions the end user can take to remedy the fault. An exemplary error message and exemplary support information, including context and remedy information, are shown below.

```
/**
**spttxt: The program is attempting to validate the
credentials on the remote agent via TCP/IP. At this
point the connection has been made, but the initial
security handshake has not been made.
**sptrem: Any failure at this point represents a
security issue. Validate that all firewalls allow
traffic over port 1024 and that the remote system is
configured to allow communication from this host.
Also check for valid installed certificates at the
remote system.
*/
if (validateSecurity(clientNode, READ) != APPROVED)
    handleError(ERROR_INVALIDCREDENTIALS, CRITICAL,
            “<%>Unable to validate security
credentials on %s</%>”, clientName);
```

Further, the meta data tool 110 is configured to generate meta data 115 linking the extracted support information with the corresponding fault notification points using unique identifiers. For example, the meta data 115 can be used to express a relationship between a unique numerical identifier for a fault notification point (e.g., “123” for the example shown in FIG. 1) and the extracted message text, context, and action support information. In an exemplary implementation, the meta data 115 can be expressed using extensible markup language (XML). In this way, the meta data tool 110 can automatically provide a support knowledge base for a software application, prior to its being released, to eliminate the need for manual documentation processes by development engineers during product development and by support engineers through discovery following product release.

Exemplary environment 100 further includes means, such as support document tool 125, for creating support documents 145 based on the meta data 115. For example, support document tool 125 can be used to generate web-based support pages accessible by support engineers 120 and end users 135, if desired, via a communications network 150. Optionally, a search engine can be used in conjunction with the web-based support pages to facilitate the searching of the support documents for specific fault notification points. Further, in an exemplary implementation, the support document tool 125 can be configured to enable the support engineers 120 to augment the support pages 145 with additional support information after the documents have been created. For example, the support engineers 120 might identify common causes or configurations that are most likely to generate a specified error message. Additionally, they might find that there is a “work around” that prevents the error message, while not actually solving the original problem causing the fault. These causes, configurations, and work arounds found in the field can be used to augment the support documentation, which then becomes a growing body of knowledge related to the specific problem/fault.

In an exemplary implementation, environment 100 includes means, such as configuration file tool 130, for processing the meta data 115 to automatically generate trigger definitions specifying contexts that produce the fault notification points during run time of the application. For example, the trigger definitions can be implemented as configuration files that control a monitoring program, such as monitoring tool 140, which monitors the application for fault notification points during execution, or run time. In other words, the configuration files can specify when the monitoring tool 140 should detect that one of the notification points has arisen. In this way, the configuration file tool 130 can automatically create trigger definitions using the support knowledge base generated by the meta data tool 110, upon compilation of the source code, to eliminate the need for manual trigger definition creation by development engineers during product development.

In an exemplary implementation, environment 100 includes means, such as monitoring tool 140, for monitoring the application during run time to detect the fault notification points in accordance with the trigger definitions. For example, the monitoring tool 140 can be configured to alert the end users 135 when fault notification points occur so that the end users 135 can obtain support information to remedy the faults.

In another exemplary implementation, environment 100 includes means, such as support documents database 145, for providing support information corresponding to the detected fault notification points using support documents created based on the meta data 115 generated during compilation of application source code. In the embodiment of FIG. 1, environment 100 includes support engineers 120, who can access the support documents 145 to provide appropriate support information to the end users 135 via the communications network 150. Optionally, environment 100 is configured such that the end users 135 can access the support documents 145 directly via the communications network 150.

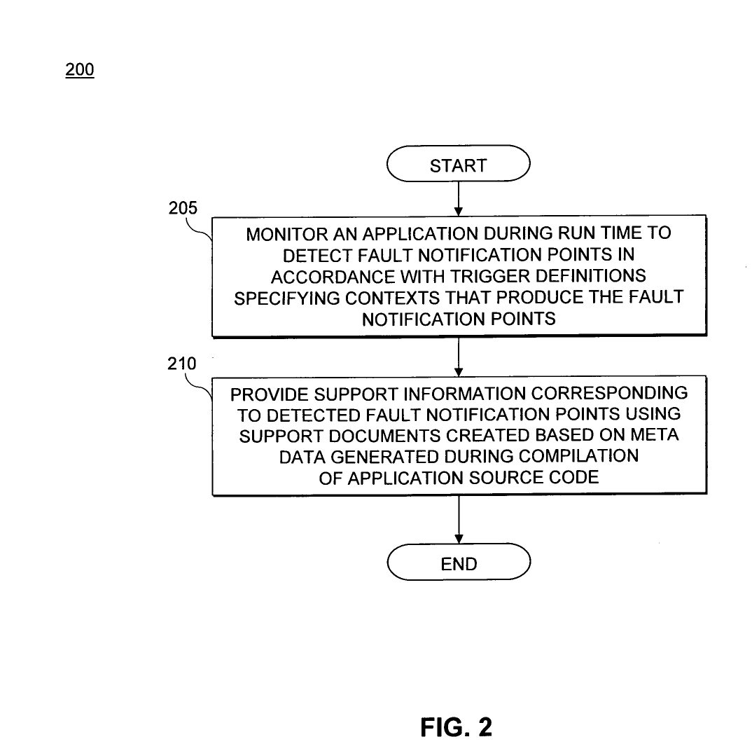

FIG. 2 illustrates a method 200 for providing support information instantiated using application development data in accordance with exemplary embodiments. Not all of the steps of FIG. 2 have to occur in the order shown, as will be apparent to persons skilled in the relevant art(s) based on the teachings herein. Other operational and structural embodiments will be apparent to persons skilled in the relevant art(s) based on the following discussion. These steps are described in detail below.

In step 205, an application is monitored during run time to detect fault notification points in accordance with trigger definitions specifying contexts that produce the fault notification points. For example, the monitoring tool 140, shown in the embodiment of FIG. 1, can be employed to monitor the application during run time for the contexts that produce the fault notification points, and can be configured to alert the end users 135 when fault notification points are detected. Once alerted, the end users 135 can contact the support engineers 120 via the communications network 150 to obtain support information pertaining to the detected fault notification points.

In step 210, support information corresponding to the detected fault notification points is provided using support documents created based on meta data generated during compilation of application source code. In an exemplary embodiment, the meta data is generated by automatically detecting marked text strings in the application source code that describe the fault notification points and extracting support information from each marked text string that corresponds to the fault notification points. In another exemplary embodiment, the trigger definitions are automatically generated by processing the meta data. Optionally, in step 210, an XML file comprising the meta data can be generated.

For example, the support engineers 120, shown in the embodiment of FIG. 1, can access the support documents 145 pertaining to the detected fault notification points to provide the applicable support information to the end users 135 via the communications network 150. In an exemplary implementation, the support documents 145 can be provided to the end users 135 via the communications network 150. In this case, the end users 135 can access the support information directly, without having to first communicate with the support engineers 120. In an exemplary implementation, the support information provided for each of the detected fault notification points includes fault notification point text, the context that produced the fault, and actions for remedying the fault.

In an exemplary implementation, the meta data tool 110, shown in the embodiment of FIG. 1, can be employed to generate the meta data 115. For example, the development engineers 105 can identify text strings in the application source code that describe the fault notification points with a predetermined marker or character/character string. The meta data tool 110 can be configured such that during compilation of the application source code, the predetermined marker or character/character strings used by the development engineers 105 are detected, and the support information from each of the detected marked text strings is extracted. In an exemplary implementation, the configuration file tool 130, shown in the embodiment of FIG. 1, can be employed to process the meta data 115 to generate the trigger definitions. In another exemplary implementation, the support document tool 125 can be employed to create the support documents 145 based on the meta data 115.

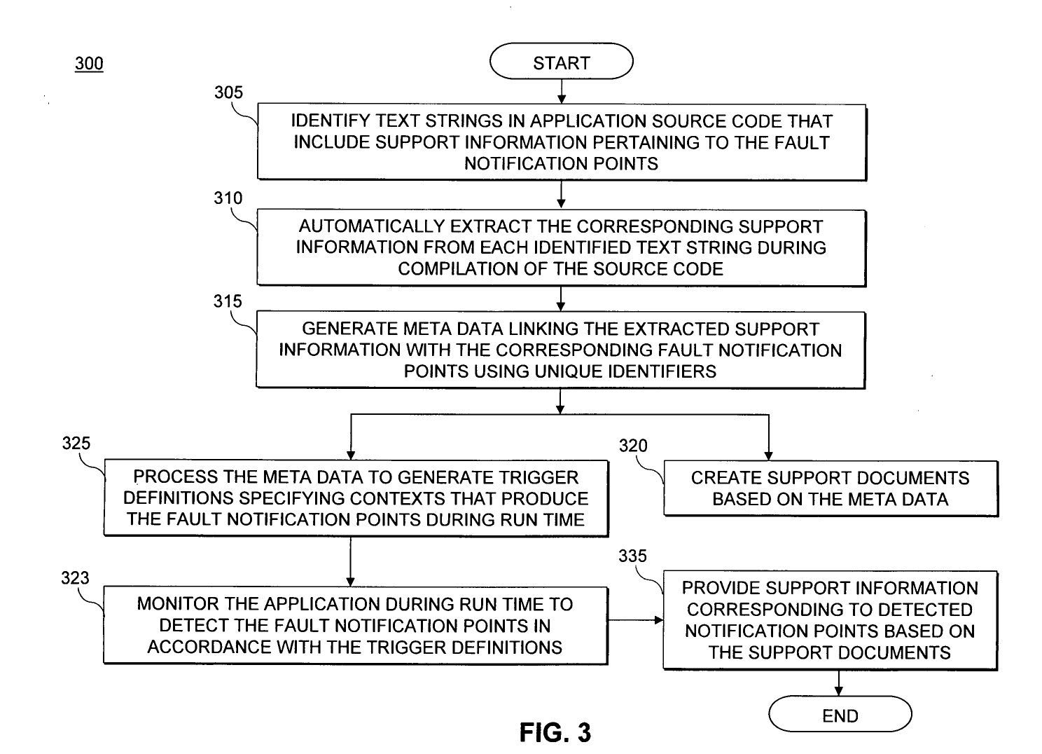

FIG. 3 illustrates a method 300 for using application development data to instantiate support information in accordance with exemplary embodiments. Not all of the steps of FIG. 3 have to occur in the order shown, as will be apparent to persons skilled in the relevant art(s) based on the teachings herein. Other operational and structural embodiments will be apparent to persons skilled in the relevant art(s) based on the following discussion. These steps are described in detail below.

In step 305, text strings are identified in application source code that describe fault notification points. The text strings can include support information pertaining to the fault notification points. For example, during development of the application source code, the development engineers 105, shown in the embodiment of FIG. 1, can identify the text strings in the application source code that describe the fault notification points with a predetermined marker or character/character string. Optionally, step 305 can include identifying log calls in the application source code that describe the fault notification points. In this case, the development engineers 105 can identify log calls in the application source code that describe the fault notification points with the predetermined marker or character/character string instead of, or in addition to, identifying the text strings that describe the fault notification points.

In step 310, the support information is automatically extracted from each identified text string during compilation of the application source code. For example, meta data tool 110, shown in the embodiment of FIG. 1, can be configured to detect the predetermined marker or character/character string used by the development engineers 105 to identify the text strings describing the fault notification points, and to extract the support information from the detected marked text strings. In one implementation, the extracted support information for each identified text string can include fault notification point text, a context that produced the fault, and actions for remedying the fault. Optionally, step 310 can include storing the extracted support information for each text string as unique entries in a message catalog.

In step 315, meta data is generated linking the extracted support information with the corresponding fault notification points using unique identifiers. For example, meta data tool 110, shown in the embodiment of FIG. 1, can be configured to link the extracted support information with the corresponding fault notification points using unique numerical identifiers associated with each of the fault notification points. Optionally, step 315 can include generating an XML file comprising the meta data. In one implementation, the XML file can be used for developing the support documents in step 320.

In step 320 support documents are created based on the meta data. For example, support document tool 125, shown in FIG. 1, can be configured to generate the support documents 145 using the meta data 115 generated in step 315 for use by the support engineers 120 in assisting the end users 135. Optionally, step 320 can include augmenting the support documents with additional support information after compilation of the application source code. For example, if the support engineers 120 discover additional support information for a particular fault notification point, the support document tool 125 can be used to augment the corresponding support documents 145 with the additional support information, such as causes, configurations, and work arounds found in the field.

In one implementation, the method 300 includes step 325. In step 325, the meta data is processed to automatically generate trigger definitions specifying contexts that produce the fault notification points during run time. For example, configuration file tool 130, shown in the embodiment of FIG. 1, can be configured to process the meta data 115 generated in step 315 to generate the trigger definitions.

In one implementation, the method 300 includes step 330. In step 330, the application is monitored during run time to detect the fault notification points in accordance with the trigger definitions. For example, the monitoring tool 140, shown in FIG. 1, can be configured to monitor the application and alert the end users 135 when contexts arise that produce the fault notification points.

In one implementation, the method 300 includes step 335. In step 335, support information is provided corresponding to the detected fault notification points based on the support documents. For example, the support engineers 120, shown in embodiment of FIG. 1, can access the support documents 145 pertaining to the detected fault notification points to provide the applicable support information to the end users 135 via the communications network 150. Optionally, step 335 can include providing the support documents to an end user via a communications network. In this case, the end users 135 can directly access the support documents 145, for example, via web pages configured with a search engine.

The present invention has been described with reference to several exemplary embodiments, however, it will be readily apparent to persons of skill in the relevant art(s) that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for providing support information instantiated using application development data, comprising:
monitoring the application during run time to detect fault notification points in accordance with trigger definitions specifying contexts that produce the fault notification points; and
providing support information corresponding to the detected fault notification points using support documents created based on meta data generated during compilation of application source code,
wherein the meta data is generated by automatically detecting marked text strings in the application source code that describe the fault notification points and extracting from each marked text string support information that corresponds to the fault notification points, and
wherein the trigger definitions are automatically generated by processing the meta data.

2. The method of claim 1, wherein the providing support information comprises:
providing, for each of the detected fault notification points, fault notification point text, the context that produced the fault, and actions for remedying the fault.

3. The method of claim 1, wherein the providing support information comprises:
providing the support documents to an end user via a communications network.

4. The method of claim 1, wherein an extensible markup language (XML) file comprising the meta data is generated.

5. A method for using application development data to instantiate support information, comprising:
identifying text strings in application source code that describe fault notification points, wherein the text strings comprise support information pertaining to the fault notification points;
automatically extracting the support information from each identified text string during compilation of the application source code;
generating meta data linking the extracted support information with the corresponding fault notification points using unique identifiers; and
creating support documents based on the meta data.

6. The method of claim 5, wherein the identifying step comprises:
identifying log calls in the application source code that describe the fault notification points.

7. The method of claim 5, wherein the support information for each identified text string includes fault notification point text, a context that produced the fault, and actions for remedying the fault.

8. The method of claim 5, wherein the extracting comprises:
storing the extracted support information for each text string as unique entries in a message catalog.

9. The method of claim 5, wherein the generating meta data comprises:
generating an extensible markup language (XML) file comprising the meta data.

10. The method of claim 5, wherein the creating support documents comprises:
augmenting the support documents with additional support information.

11. The method of claim 5, further comprising:
processing the meta data to automatically generate trigger definitions specifying contexts that produce the fault notification points during run time.

12. The method of claim 11, further comprising:
monitoring the application during run time to detect the fault notification points in accordance with the trigger definitions.

13. The method of claim 12, further comprising:
providing support information corresponding to the detected fault notification points based on the support documents.

14. The method of claim 12, wherein the providing support information comprises:
providing the support documents to an end user via a communications network.

15. A system for providing support information instantiated using application development data, comprising:
means for monitoring the application during run time to detect fault notification points in accordance with trigger definitions specifying contexts that produce the fault notification points; and
means for providing support information corresponding to the detected fault notification points using support documents created based on meta data generated during compilation of application source code,
wherein the meta data is generated by automatically detecting marked text strings in the application source code that describe the fault notification points and extracting from each marked text string support information that corresponds to the fault notification points, and
wherein the trigger definitions are automatically generated by processing the meta data.

16. The system of claim 15, wherein the support information for each marked text string includes fault notification point text, the context that produced the fault, and actions for remedying the fault.

17. A system for using application development data to instantiate support information, comprising:
means for automatically detecting, during compilation of application source code, marked text strings describing fault notification points, extracting support information from each marked text string, and generating meta data linking the extracted support information with the corresponding fault notification points using unique identifiers; and
means for creating support documents based on the meta data.

18. The system of claim 17, wherein the support information for each marked text string includes fault notification point text, a context that produced the fault, and actions for remedying the fault

19. The system of claim 17, further comprising:
means for processing the meta data to automatically generate trigger definitions specifying contexts that produce the fault notification points during run time of the application.

20. The system of claim 19, further comprising:
means for monitoring the application during run time to detect the fault notification points in accordance with the trigger definitions.
